(19) United States
(12) Patent Application Publication
(10) Pub. No.: US 2025/0356784 A1
(43) Pub. Date: Nov. 20, 2025

(54) MURA COMPENSATION APPARATUS AND DISPLAY DRIVING APPARATUS

(71) Applicant: LX SEMICON CO., LTD, Daejeon (KR)

(72) Inventor: Doo Hwa JANG

(73) Assignee: LX SEMICON CO., LTD, Daejeon (KR)

(21) Appl. No.: 19/114,303

(22) PCT Filed: Sep. 18, 2023
(86) PCT No.: PCT/KR2023/014026

§ 371 Date: Mar. 21, 2025

(30) Foreign Application Priority Data
Sep. 22, 2022 (KR) 1020220119914

(51) Int. Cl. G09G 3/00

(52) U.S. Cl. CPC G09G 3/006; G09G 2320/0233; G09G 2330/12

(57) ABSTRACT

A mura compensation apparatus includes a compensation parameter calculation unit; a compensation parameter range calculation unit; a local compensation parameter determination unit that determines, as a local compensation parameter, a compensation parameter having the largest compensation parameter range from among first to third compensation parameters, and calculates compensation parameter range data of the compensation parameter determined as the local compensation parameter; and a mura compensation data output unit for outputting mura compensation data by using first to third compensation parameter data and first to third compensation parameter range data for the first to third compensation parameters, and local compensation parameter data and local compensation parameter range data for the local compensation parameter.

### CROSS-REFERENCE TO RELATED APPLICATIONS

This application is a national phase entry of PCT International Application No. PCT/KR2023/014026 filed on Sep. 18, 2023, which claims the priority of Korean Application No. 10-2022-0119914 filed on Sep. 22, 2022, which are hereby incorporated by reference in their entirety.

### BACKGROUND

### Field of the Disclosure

The present disclosure relates to a mura compensation apparatus and a display driving apparatus.

### Description of the Background

Representative examples of display devices for displaying an image include a liquid crystal display (LCD) using liquid crystals and an organic light-emitting diode (OLED) display using organic light-emitting diodes.

Due to non-uniformity in the display panel manufacturing process, defects may occur in which bright spots or stains (mura) are visually recognized at specific pixels or at some areas of the display panel. To solve this problem, a mura compensation method is being researched.

The present disclosure is directed to solving the above-described problem, and its technical task is to provide a mura compensation apparatus and a display driving apparatus for minimizing defects in which bright spots or stains are visually recognized at specific pixels and some areas due to non-uniformity in the display panel manufacturing process.

### SUMMARY

A mura compensation apparatus according to an aspect of the present disclosure includes: a compensation parameter calculation part configured to calculate first to third compensation parameter data, which are data for first to third compensation parameters in a mura compensation formula, for each unit block by using first to third test image data and first to third captured image data, wherein the first to third captured image data are obtained by capturing the first to third test images displayed on the display panel by inputting the first to third test image data into the display panel, and are composed of unit blocks including at least one pixel;
a compensation parameter range calculation part configured to calculate first to third compensation parameter range data for all the unit blocks by using the first to third compensation parameters;
a local compensation parameter determination part configured to determine the compensation parameter exhibiting the greatest variation in values among the first to third compensation parameters for the unit blocks as a local compensation parameter, and to calculate local compensation parameter data, which are data for the local compensation parameter, and local compensation parameter range data for the compensation parameter determined as the local compensation parameter; and
a mura compensation data output part configured to output mura compensation data by using the first to third compensation parameter data and first to third compensation parameter range data; and local compensation parameter data and local compensation parameter range data for the local compensation parameter.

A mura compensation apparatus and a display driving apparatus according to an aspect of the present disclosure may minimize defects in which bright spots or stains are visually recognized at specific pixels and some areas due to non-uniformity in the display panel manufacturing process.

### BRIEF DESCRIPTION OF THE DRAWINGS

FIG. 1 is a diagram briefly illustrating a process of detecting mura in a display panel by using a mura compensation apparatus according to an aspect of the present disclosure.

FIG. 2 is a block diagram of a mura compensation apparatus according to an aspect of the present disclosure.

FIG. 3 is a detailed diagram of a process of detecting mura in a display panel by using a mura compensation apparatus according to an aspect of the present disclosure.

FIG. 4 is a diagram illustrating a range of first to third compensation parameters in a mura compensation formula, calculated for all unit blocks in a mura compensation apparatus according to an aspect of the present disclosure.

FIGS. 5A to 5D are diagrams illustrating data included in mura compensation data according to an aspect of the present disclosure.

FIG. 6 is a diagram illustrating a process of compensating for mura by using first to third compensation parameters, which are calculated according to an aspect of the present disclosure and stored in a register of a display driving apparatus.

### DETAILED DESCRIPTION

Throughout the disclosure, the same reference numerals refer to substantially the same components. In the following description, detailed descriptions of configurations and features known in the art may be omitted if they are not relevant to the core configuration of the present disclosure. Terms used in this disclosure should be understood as follows.

The advantages and features of the present disclosure, and methods of achieving them will be apparent from the aspects described in detail below in conjunction with the accompanying drawings. However, the present disclosure is not limited to the following aspects, but may be implemented in various different forms; rather, the present aspects are provided to make the description of the present disclosure complete and to allow those skilled in the art to fully understand the scope of the present disclosure, and the present disclosure is defined only within the scope of the appended claims.

The shapes, sizes, proportions, angles, numbers and the like shown in the accompanying drawings for the purpose of illustrating the aspects of the present disclosure are merely examples, and the present disclosure is not limited thereto. Identical reference numerals may designate identical components throughout the description. Further, in describing the present disclosure, detailed descriptions of known related technologies may be omitted if it is considered to unnecessarily obscure the gist of the present disclosure.

The terms such as “including,” “having,” “comprising,” or the like used herein are generally intended to allow other components to be added unless the terms are used with the term “only.” References to components of a singular noun include the plural of that noun, unless specifically stated otherwise.

In interpreting components, they are construed to include a margin of error, even if it is not explicitly stated.

When describing a temporal contextual relationship is described, for example, such as “after,” “following,” “next to,” or “before,” it may also include non-contiguous cases unless “immediately” or “directly” is used.

The first, the second, and so on are used to describe various components, but these components are not limited by these terms. These terms are used only to distinguish one component from another. Therefore, the first component referred to herein may also be a second component within the technical idea of the present disclosure.

It should be understood that the term “at least one” includes any combination that may be presented from one or more relevant items. For example, the phrase of “at least one of the first, second, and third items” may mean each of the first, second, or third items, as well as any combination of items that may be presented from two or more of the first, second, and third items.

Each of the features of various aspects of the present disclosure may be coupled or combined with one another in whole or in part, and may be technologically interlocked and operated in various ways, and each of the aspects may be carried out independently or in conjunction with one another.

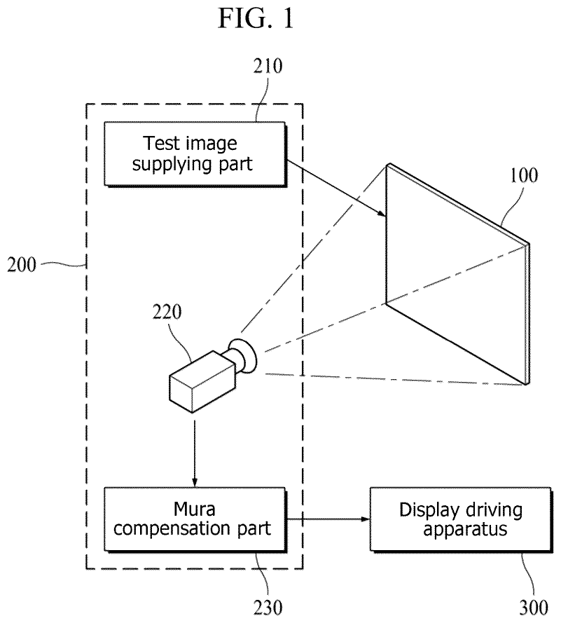

Hereinafter, a mura compensation apparatus according to an aspect of the present disclosure will be described in detail with reference to FIGS. 1 to 5D.

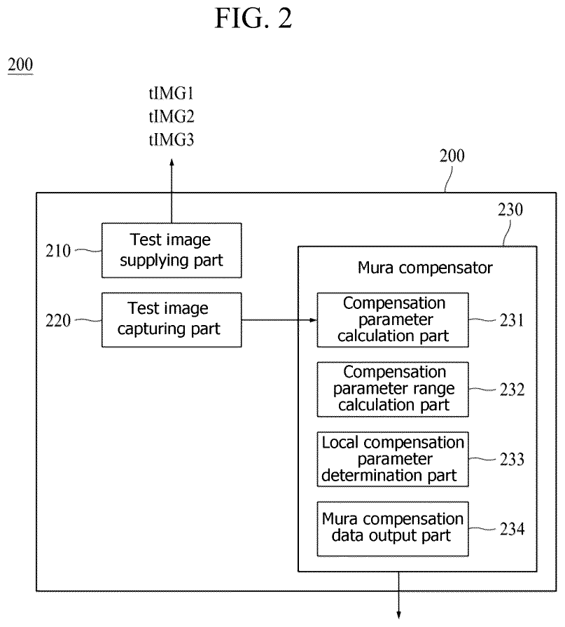

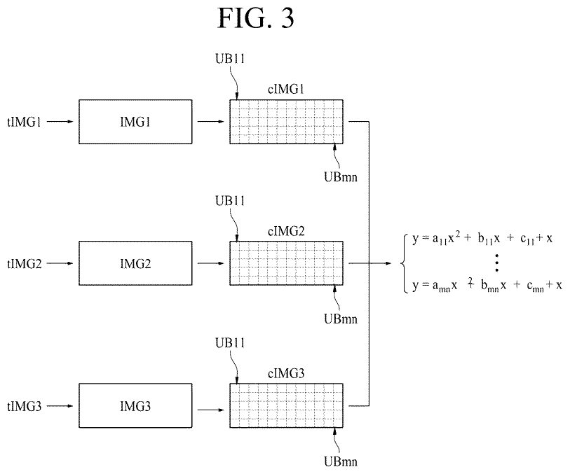

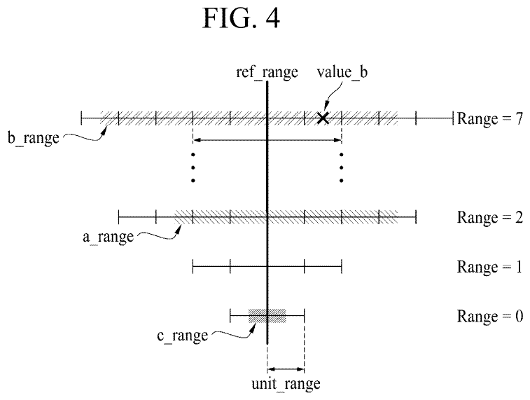

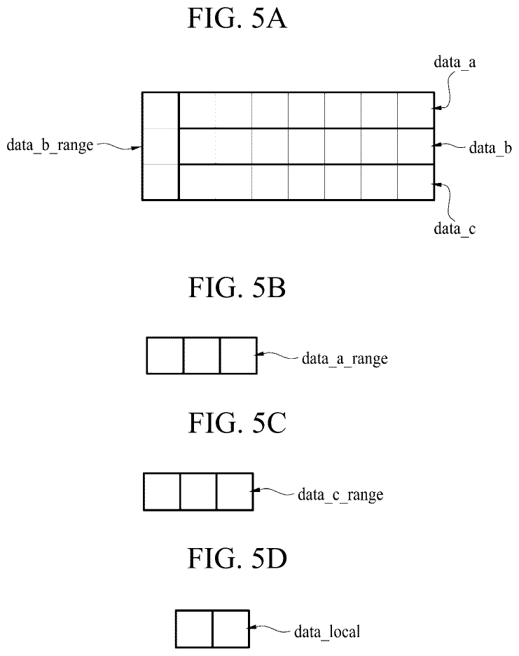

FIG. 1 is a diagram briefly illustrating a process of detecting mura in a display panel by using a mura compensation apparatus according to an aspect of the present disclosure. FIG. 2 is a block diagram of a mura compensation apparatus according to an aspect of the present disclosure. FIG. 3 is a detailed diagram of a process of detecting mura in a display panel by using a mura compensation apparatus according to an aspect of the present disclosure. FIG. 4 is a diagram illustrating a range of first to third compensation parameters in a mura compensation formula, calculated for all unit blocks in a mura compensation apparatus according to an aspect of the present disclosure. FIGS. 5A to 5D are diagrams illustrating data included in mura compensation data according to an aspect of the present disclosure.

Referring to FIG. 1, a mura compensation apparatus 200 provides test image data to a display panel 100, captures an image displayed on the display panel 100 to measure mura, calculates compensation parameters in a mura compensation formula and ranges of the respective compensation parameters for compensating the measured mura, and stores the calculated values in a register of a display driving apparatus 300 that drives the display panel 100.

The display panel 100 may display an image of a predetermined grayscale by using light emitted from a backlight unit. The display panel 100 may be a flat panel display panel, such as a liquid crystal display (LCD) panel or an organic light-emitting diode (OLED) panel.

The display panel 100 includes a plurality of gate lines, a plurality of data lines, and a plurality of pixels, although not illustrated. Each of the plurality of gate lines receives a scan pulse. Each of the plurality of data lines receives a data signal during a display period. Each of the plurality of gate lines and the plurality of data lines is positioned to intersect each other on a substrate to define a plurality of pixels. Each of the plurality of pixels may include a thin-film transistor connected to an adjacent gate line and data line, a pixel electrode connected to the thin-film transistor, and a storage capacitor connected to the pixel electrode.

The pixels of the display panel 100 may include sub-pixels of a first color, a second color, and a third color, and may further include sub-pixels of a fourth color. In this case, the first color may be any one of red, green, and blue, the second color may be another one of red, green, and blue, and the third color may be the remaining one of red, green, and blue. Additionally, the fourth color may be white (W). For example, each sub-pixel may be repeatedly formed in a row direction or may be formed in a 2*2 matrix pattern. In this case, a color filter corresponding to each color is arranged in each of the sub-pixels of the first color, the second color, and the third color, whereas no separate color filter is arranged in the sub-pixel of the fourth color. In one aspect, the sub-pixels of the first color, the second color, the third color, and the fourth color may be formed to have the same area ratio, but may also be formed to have different area ratios.

The display panel 100 may have bright spots or stains visually recognized at some pixels or some areas due to non-uniformity in the manufacturing process. According to an aspect of the present disclosure, display defects of the display panel 100 may be detected and compensated for, thereby improving the display quality of the display panel 100.

A mura compensation apparatus 200 according to an aspect of the present disclosure includes a test image supplying part 210, a test image capturing part 220, and a mura compensator 230, as illustrated in FIGS. 1 and 2.

The test image supplying part 210 provides test image data to the display panel 100. The test image data may be composed of image data corresponding to each sub-pixel of the display panel 100. According to an aspect of the present disclosure, the test image data may include at least three test image data. For example, the test image supplying part 210 provides first to third test image data tIMG1, tIMG2, and tIMG3 to the display panel 100, as illustrated in FIG. 3. In this case, each of the first to third test image data may be image data for displaying different grayscale levels. For example, the first test image data tIMG1 may be image data for displaying an 18-level grayscale, the second test image data tIMG2 may be image data for displaying a 48-level grayscale, and the third test image data tIMG3 may be image data for displaying a 100-level grayscale.

The display panel 100 may display images corresponding to first to third test image data tIMG1, tIMG2, and tIMG3 received from the test image supplying part 210. That is, the display panel 100 may display first to third image data IMG1, IMG2, and IMG3 corresponding to first to third test image data tIMG1, tIMG2, and tIMG3, respectively, as illustrated in FIG. 3.

The test image capturing part 220 captures images displayed on the display panel 100 to detect and analyze mura and acquires first to third captured image data cIMG1, cIMG2, and cIMG3. Specifically, the test image capturing part 220 captures first to third test images tIMG1, tIMG2, and tIMG3 to acquire first to third captured image data cIMG1, cIMG2, and cIMG3, as illustrated in FIG. 3. In this case, each of the first to third captured image data cIMG1, cIMG2, and cIMG3 may be composed of unit blocks including at least one pixel of the first to third captured image data cIMG1, cIMG2, and cIMG3, as illustrated in FIG. 3. Each of the first to third captured image data cIMG1, cIMG2, and cIMG3 is composed of unit blocks including the same number of pixels, so that the respective unit blocks of the first to third captured image data cIMG1, cIMG2, and cIMG3 may correspond to each other.

Although not illustrated, the mura compensation apparatus 200 may further include a capturing calibrator to acquire captured image data more accurately. The capturing calibrator may receive captured image data obtained by capturing images displayed on the display panel 100 with the test image capturing part 220 and correct the capturing state of the test image capturing part 220 to prevent errors caused by the test image capturing part 220. To this end, the capturing calibrator may display calibration information for correcting the capturing state on a separate display device or provide feedback of the calibration information to the test image capturing part 220 based on the analysis result of the captured image data obtained by capturing the test image displayed on the display panel 100. When the capturing calibrator displays the calibration information on a separate display device, a user may check the calibration information and correct the capturing state of the test image capturing part 220. Alternatively, the test image capturing part 220 may automatically correct the capturing state by referring to the feedback calibration information.

The mura compensator 230 detects mura by using first to third test image data tIMG1, tIMG2, and tIMG3 and first to third captured image data cIMG1, cIMG2, and cIMG3. In this case, the mura compensator 230 may compensate for mura by using a mura compensation formula y=ax²+c+x. Specifically, the mura compensator 230 compensates for mura by using first to third compensation parameters a, b, and c, which constitute a mura compensation formula y=ax²+bx+c+x, and first to third compensation parameter ranges a_range, b_range, and c_range. That is, the mura compensator 230 calculates first to third compensation parameters a, b, and c in a mura compensation formula for each unit block composing the first to third captured image data cIMG1, cIMG2, and cIMG3 and calculates the range of each compensation parameter for all unit blocks. Specifically, according to an aspect of the present disclosure, the mura compensator 230 determines the compensation parameter exhibiting the largest compensation parameter range among all unit blocks, meaning the compensation parameter with the greatest variation (error) in values for each unit block, as a local compensation parameter, and calculates the compensation parameter range for each unit block for the compensation parameter determined as the local compensation parameter. Accordingly, the mura compensator 230 may more accurately compensate for mura by using the local compensation parameter, which is the compensation parameter exhibiting the greatest variation (error) in values among the first to third compensation parameters for each unit block. That is, by calculating information on the local compensation parameter that has the greatest impact on mura, mura may be more accurately compensated for while minimizing the usage capacity of the register in the display driving apparatus 300.

Additionally, the mura compensator 230 stores mura compensation data, which includes data on each calculated compensation parameter, each compensation parameter range, the local parameter, and the local parameter range, in a register of the display driving apparatus 300. Accordingly, the display driving apparatus 300 compensates for mura by using the data stored in the register and the mura compensation formula when driving the display panel 100.

The mura compensator 230 includes a compensation parameter calculation part 231, a compensation parameter range calculation part 232, a local compensation parameter determination part 233, and a mura compensation data output part 234.

The compensation parameter calculation part 231 detects mura by using first to third captured image data cIMG1, cIMG2, and cIMG3 and calculates first to third compensation parameters a, b, and c in a mura compensation formula for compensating for mura. Specifically, the compensation parameter calculation part 231 divides first to third test image data tIMG1, tIMG2, and tIMG3 and first to third captured image data cIMG1, cIMG2, and cIMG3 into unit blocks UB11 to UBmn, each including at least one pixel, and calculates compensation parameters a, b, and c in the mura compensation formula by using the test image data tIMG1, tIMG2, and tIMG3 and the captured image data cIMG1, cIMG2, and cIMG3 corresponding to each unit block UB11 to UBmn.

As illustrated in FIG. 3, the compensation parameter calculation part 231 divides each of the first to third test image data tIMG1, tIMG2, and tIMG3 and the first to third captured image data cIMG1, cIMG2, and cIMG3 into unit blocks UB11 to UBmn. The compensation parameter calculation part 231 applies the first to third test image data tIMG1, tIMG2, and tIMG3 to x in the mura compensation formula y=ax²+bx+c+x and applies the first to third captured image data cIMG1, cIMG2, and cIMG3 to y in the mura compensation formula for the corresponding unit blocks, thereby deriving three simultaneous equations for the first to third compensation parameters of each unit block. The compensation parameter calculation part 231 calculates first to third compensation parameters a, b, and c in the mura compensation formula for each unit block by using the derived simultaneous equations. For example, the compensation parameter calculation part 231 calculates a first equation for the first to third compensation parameters a_{R11}, b_{R11}, and c_{R11} of the first-first unit block UB11 by using the first test image data tIMG1 and the first captured image data cIMG1 of the first-first unit block UB11. The compensation parameter calculation part 231 then calculates a second equation for the first to third compensation parameters a_{R11}, b_{R11}, and c_{R11} of the first-first unit block UB11 by using the second test image data tIMG2 and the second captured image data cIMG2 of the first-first unit block UB11. The compensation parameter calculation part 231 further calculates a third equation for the first to third compensation parameters a_{R11}, b_{R11}, and c_{R11} of the first-first unit block UB11 by using the third test image data tIMG3 and the third captured image data cIMG3 of the first-first unit block UB11. The compensation parameter calculation part 231 solves the calculated first to third equations as a system of simultaneous equations to calculate the first to third compensation parameters a_{R11}, b_{R11}, and c_{R11} in the mura compensation formula for the first-first unit block UB11.

The compensation parameter range calculation part 232 respectively calculates the range of each compensation parameter by using the first to third compensation parameters calculated by the compensation parameter calculation part 231. Specifically, the compensation parameter range calculation part 232 respectively calculates first to third compensation parameter ranges a_range, b_range, and c_range for all unit blocks by using the first to third compensation parameters for each unit block calculated by the compensation parameter calculation part 231. For example, first to third compensation parameter ranges a_range, b_range, and c_range for all unit blocks may respectively be calculated as illustrated in FIG. 4. The size of the second compensation parameter range b_range may be the largest, while the size of the third compensation parameter range c_range may be the smallest.

Additionally, the compensation parameter range calculation part 232 calculates first to third compensation parameter range data by using the first to third compensation parameter ranges a_range, b_range, and c_range calculated for all unit blocks. Specifically, the compensation parameter range calculation part 232 determines a parameter range step according to the parameter range step and generates the parameter range step of the determined compensation parameter range as compensation parameter range data. In this case, the compensation parameter range calculation part 232 may classify the parameter range step into eight steps, from step 0 to step 7, according to the set range by using a predetermined reference range ref_range and a predetermined unit range unit_range. That is, as illustrated in FIG. 4, each parameter range step includes a range that is greater or smaller by a factor of 2 raised to the power of the parameter range step of the predetermined unit range unit_range from the predetermined reference range ref_range and has a range size that is twice the size of 2 raised to the power of the parameter range step of the unit range unit_range. That is, the parameter range step of step 0 may include a range that is greater or smaller by a value corresponding to 1 (=2²⁰) times the predetermined unit range (unit_range) from the predetermined reference value and have a range size that is 1×2 times the predetermined unit range (unit_range). The parameter range step of step 1 may include a range that is greater or smaller by a value corresponding to 2 (=2¹) times the predetermined unit range (unit_range) from the predetermined reference value and have a range size that is 2×2 times the predetermined unit range (unit_range). The parameter range step of step 2 may include a range that is greater or smaller by a value corresponding to 4 (=2²) times the predetermined unit range (unit_range) from the predetermined reference value and have a range size that is 4×2 times the predetermined unit range (unit_range).

The local compensation parameter determination part 233 respectively compares the sizes of the first to third compensation parameter ranges a_range, b_range, and c_range calculated by the compensation parameter range calculation part 232 and determines the compensation parameter with the largest compensation parameter range among the first to third compensation parameters as the local compensation parameter. That is, the local compensation parameter determination part 233 determines the compensation parameter with the variation in values for each unit block compensation parameter among all unit blocks as the local compensation parameter. Specifically, the local compensation parameter determination part 233 may determine the compensation parameter with the largest compensation parameter range among the first to third compensation parameters as the local compensation parameter by using at least one of the first to third compensation parameter ranges a_range, b_range, and c_range and the first to third compensation parameter range data data_a_range, data_b_range, and data_c_range, which are calculated by the compensation parameter range calculation part 232. That is, the local compensation parameter determination part 233 may respectively calculate the sizes of the first to third compensation parameter ranges a_range, b_range, and c_range, compare the calculated sizes of the first to third compensation parameter ranges a_range, b_range, and c_range, and determine the compensation parameter with the largest compensation parameter range as the local compensation parameter. Additionally, the local compensation parameter determination part 233 may determine the compensation parameter with the largest compensation parameter range data as the local compensation parameter by using the calculated first to third compensation parameter range data data_a_range, data_b_range, and data_c_range. Alternatively, the local compensation parameter determination part 233 may determine the compensation parameter with the largest compensation parameter range and the largest compensation parameter range data as the local compensation parameter by using both the sizes of the first to third compensation parameter ranges a_range, b_range, and c_range and the first to third compensation parameter range data data_a_range, data_b_range, and data_c_range. For example, as illustrated in FIG. 4, the local compensation parameter determination part 233 respectively calculates the sizes of the first to third compensation parameter ranges a_range, b_range, and c_range or determines the second compensation parameter b as the local compensation parameter, which has the largest compensation parameter range, by using the first to third compensation parameter range data data_a_range, data_b_range, and data_c_range.

In this case, the local compensation parameter determination part 233 generates local data data local, which is data for the compensation parameter designated as the local compensation parameter. For example, when the first compensation parameter a is the local compensation parameter, the local data data_local may have a value of “01.” When the second compensation parameter b is the local compensation parameter, the local data data_local may have a value of “10.” When the third compensation parameter c is the local compensation parameter, the local data data_local may have a value of “11.” However, the value of the local data data local is not limited thereto.

Additionally, the local compensation parameter determination part 233 generates the compensation parameter range data for the unit block as local compensation parameter range data for the compensation parameter determined as the local compensation parameter. Specifically, when a compensation parameter is determined as the local compensation parameter, the local compensation parameter determination part 233 generates the compensation parameter range data, which is data on the range of the compensation parameter for each unit block, as the local compensation parameter range data. For example, as described above, when the second compensation parameter b is determined as the local compensation parameter, the local compensation parameter determination part 233 generates the compensation parameter range data data_b_range, which corresponds to the range (Range=1) including the value value_b of the second compensation parameter b for the unit block, as the local compensation parameter range data, with a corresponding value of 1. Meanwhile, for the first compensation parameter a and the third compensation parameter c, which are not determined as the local compensation parameter, the compensation parameter range data data_a_range is generated with a corresponding value of 2, which corresponds to the range (Range=2) including the first compensation parameter range a_range for all unit blocks. Additionally, the compensation parameter range data data_c_range is generated with a corresponding value of 0, which corresponds to the range (Range=0) including the third compensation parameter range c_range for all unit blocks. In this case, since the local compensation parameter determination part 233 generates local compensation parameter range data for each unit block when the compensation parameter is determined as the local compensation parameter, the local compensation parameter determination part 233 may generate the same number of local compensation parameter range data as the number of unit blocks.

Accordingly, since the local compensation parameter, which is the compensation parameter exhibiting the greatest variation (error) in values for each unit block, is used to compensate for mura by calculating local compensation parameter range data as the compensation parameter range data for each unit block, the mura compensation apparatus according to an aspect of the present disclosure may minimize the register usage of the display driving apparatus 300 while more accurately calculating the compensation parameter for each unit block.

The mura compensation data output part 234 generates mura compensation data by using each compensation parameter and the compensation parameter range data calculated for all unit blocks for the compensation parameters that are not determined as the local compensation parameter, the local compensation parameter and the local compensation parameter range data for the compensation parameter determined as the local compensation parameter, and the local data data_local, which is data for the local compensation parameter. The mura compensation data output part 234 then outputs and stores the generated mura compensation data in a register of the display driving apparatus 300.

The mura compensation data output part 234 generates compensation parameter data for the compensation parameters that are not determined as the local compensation parameter by using each compensation parameter and the compensation parameter range data calculated for each unit block by the compensation parameter calculation part 231. For the compensation parameter determined as the local compensation parameter, the mura compensation data output part 234 generates compensation parameter data by using the local compensation parameter and the local compensation parameter range data calculated by the local compensation parameter determination part 233. Specifically, the mura compensation data output part 234 divides the parameter range corresponding to each compensation parameter range data or local compensation parameter range data into 128 steps and determines the step corresponding to each compensation parameter or local compensation parameter of each unit block among the 128 divided steps as the compensation parameter data. For example, as described above, when the second compensation parameter b is determined as the local compensation parameter, the mura compensation data output part 234 divides the parameter ranges corresponding to the first and third compensation parameter range data data_a_range and data_c_range into 128 steps, respectively. Among the 128 divided steps, the steps corresponding to the first and third compensation parameters of the unit block are determined as the first and third compensation parameter data data_a and data_c, respectively. Additionally, the mura compensation data output part 234 divides the parameter range corresponding to the local compensation parameter range data data_b of the unit block into 128 steps and determines the step corresponding to the second compensation parameter, which is the local compensation parameter of the unit block, among the 128 divided steps as the second compensation parameter data data_b. In this case, the local compensation parameter range data represents data on the range of the compensation parameter for each unit block, whereas the compensation parameter range data for compensation parameters other than the local compensation parameter represents data on the range of the compensation parameter for all unit blocks.

The mura compensation data output part 234 generates mura compensation data by using the compensation parameter data and local compensation parameter range data for the compensation parameter determined as the local compensation parameter, along with the compensation parameter data and compensation parameter range data for the compensation parameters that are not determined as the local compensation parameter. Specifically, when the second compensation parameter b is the local compensation parameter, the mura compensation data includes, as illustrated in FIG. 5A, first to third compensation parameter data data_a, data_b, and data_c, each composed of 7 bits per unit block, and 3-bit compensation parameter range data data_b_range for the second compensation parameter, which is the local compensation parameter. Additionally, as illustrated in FIGS. 5B and 5C, the mura compensation data includes 3-bit compensation parameter range data data_a and data_c for all unit blocks of the compensation parameters that are not designated as the local compensation parameter. Furthermore, as illustrated in FIG. 5D, the mura compensation data includes 2-bit local data data local, which represents data for the compensation parameter designated as the local compensation parameter.

The mura compensation data output part 234 outputs and stores the generated mura compensation data in a register of the display driving apparatus 300.

Accordingly, since the local compensation parameter, which is the compensation parameter exhibiting the greatest variation (error) in values for each unit block, is used to compensate for mura by calculating local compensation parameter range data as the compensation parameter range data for each unit block, the mura compensation apparatus according to an aspect of the present disclosure may minimize the register usage of the display driving apparatus 300 while more accurately calculating the compensation parameter for each unit block.

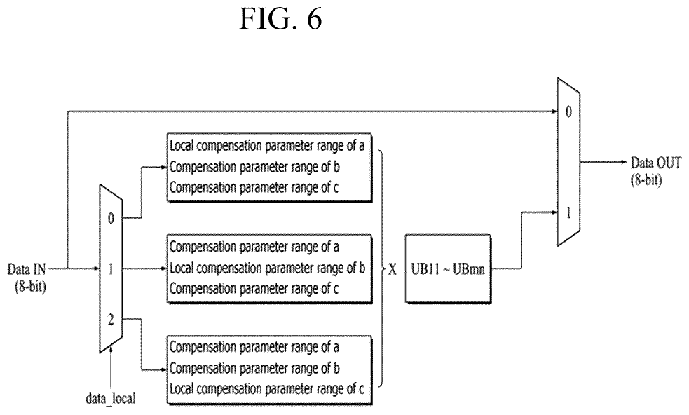

Hereinafter, a display driving apparatus according to an aspect of the present disclosure will be described in detail with reference to FIGS. 5A to 6.

FIGS. 5A to 5D are diagrams illustrating data included in mura compensation data according to an aspect of the present disclosure. FIG. 6 is a diagram illustrating a process of compensating for mura by using first to third compensation parameters, which are calculated according to an aspect of the present disclosure and stored in a register of a display driving apparatus.

A display driving apparatus 300 according to an aspect of the present disclosure may include a register that stores the mura compensation data received from the aforementioned mura compensation apparatus; and a display driver that compensates for the mura of the display by using the mura compensation data stored in the register.

As described above, the mura compensation apparatus 200 according to an aspect of the present disclosure stores, in a register of the display driving apparatus 300, mura compensation data including first to third compensation parameter data a, b, and c for each unit block; compensation parameter range data for each unit block of the compensation parameter serving as the local compensation parameter; compensation parameter range data for all unit blocks of the compensation parameters other than the local compensation parameter; and local data data_local, which is data for the local compensation parameter. Accordingly, as described above, when the second compensation parameter b is the local compensation parameter, the register of the display driving apparatus 300 stores, as illustrated in FIG. 5A, first to third compensation parameter data data_a, data_b, and data_c, each composed of 7 bits per unit block, and 3-bit compensation parameter range data data_b_range for the second compensation parameter, which is the local compensation parameter. Since the first to third compensation parameter data data_a, data_b, and data_c and the compensation parameter range data data_b_range for the local compensation parameter are stored for each unit block, they are stored in the register of the display driving apparatus 300 in the same number as the number of unit blocks. As illustrated in FIGS. 5B and 5C, the register of the display driving apparatus 300 stores 3-bit compensation parameter range data data_a and data_c for all unit blocks of the compensation parameters that are not designated as the local compensation parameter. As illustrated in FIG. 5D, the register of the display driving apparatus 300 stores 2-bit local data data local, which is data for the compensation parameter designated as the local compensation parameter. In this case, since the compensation parameter range data data_a and data_c for all unit blocks of the compensation parameters that are not designated as the local compensation parameter, as well as the local data data_local, correspond to data for all unit blocks, a single compensation parameter range data for each parameter is stored in the register of the display driving apparatus 300.

Referring to FIG. 6, the display driver of the display driving apparatus 300 applies the mura compensation formula by using the mura compensation data stored in the register to calculate a mura compensation value. Specifically, the display driver of the display driving apparatus 300 sets one of the first to third compensation parameters as the local compensation parameter by using the local data data_local stored in the register, restores the first to third compensation parameters a, b, and c for each unit block, and applies the restored first to third compensation parameters a, b, and c to the mura compensation formula to calculate the mura compensation value. For example, the display driver of the display driving apparatus 300 restores the second compensation parameter b, which is determined as the local compensation parameter, for each unit block by using the 7-bit second compensation parameter data data_b stored as illustrated in FIG. 5A and the compensation parameter range data data_b_range for the second compensation parameter b, which is the local compensation parameter. For the first and third compensation parameters a and c, which are not designated as the local compensation parameter, the display driver restores the first and third compensation parameters a and c for each unit block by using the 7-bit first and third compensation parameter data data_a and data_c stored as illustrated in FIG. 5A and the 3-bit compensation parameter range data data_a_range and data_c_range for all unit blocks of the first and third compensation parameters a and c, which are not designated as the local compensation parameter, as illustrated in FIGS. 5B and 5C. The restored first to third compensation parameters a, b, and c are applied to the mura compensation formula to calculate the corresponding mura compensation value.

Since the display driving apparatus according to an aspect of the present disclosure compensates for mura by calculating local compensation parameter range data as the compensation parameter range data for each unit block for the local compensation parameter, which is the compensation parameter exhibiting the greatest variation (error) in values for each unit block, the display driving apparatus 300 may minimize register usage while more accurately calculating the compensation parameter for each unit block.

Those skilled in the art to which the present disclosure belongs will understand that the present disclosure described above may be implemented in other specific forms without changing its technical idea or necessary features.

In addition, the methods described herein may be implemented, at least in part, using one or more computer programs or components. The component may be provided as a set of computer instructions on a computer-readable medium including volatile and non-volatile memory or a machine-readable medium. The above instructions may be provided as software or firmware and may be implemented, in whole or in part, in hardware configurations such as ASICS, FPGAs, DSPs, or other similar devices. The above instructions may be configured to be executed by one or more processors or other hardware configurations, which, when executing the above set of computer instructions, perform or cause to be performed all or a portion of the methods and procedures disclosed herein.

Therefore, it should be understood that the aspects described above are illustrative in all aspects and do not limit the present disclosure. The scope of the present disclosure is represented by the following claims rather than the above detailed description, and it should be construed that all changes or modifications derived from the meaning and scope of the claims and their equivalent concepts are included within the scope of the present disclosure.

Various aspects for implementing the present disclosure have been sufficiently described in the previous sections, and redundant descriptions will be omitted. The present disclosure is applicable to various types of display devices and the like, and thus, its industrial applicability is recognized.

What is claimed is:

1. A mura compensation apparatus comprising:
calculate first to third compensation parameter data, which are data for first to third compensation parameters in a mura compensation formula, for each unit block by using first to third test image data and first to third captured image data, wherein the first to third captured image data are obtained by capturing the first to third test images displayed on the display panel by inputting the first to third test image data into the display panel, and are composed of unit blocks including at least one pixel,
calculate first to third compensation parameter range data for all the unit blocks by using the first to third compensation parameters,
determine, among the first to third compensation parameters, a compensation parameter exhibiting the greatest variation in values for the unit blocks as a local compensation parameter, and calculating local compensation parameter data, which are data for the local compensation parameter, and local compensation parameter range data for the compensation parameter determined as the local compensation parameter, and
output mura compensation data by using the first to third compensation parameter data and the first to third compensation parameter range data, and the local compensation parameter data and the local compensation parameter range data for the local compensation parameter.

2. The mura compensation apparatus according to claim 1, wherein the local compensation parameter range data is data on the range of the compensation parameter determined as the local compensation parameter for each unit block, and
a local compensation parameter determination part included in the mura compensation apparatus calculates the local compensation parameter range data for each unit block.

3. The mura compensation apparatus according to claim 1, wherein the mura compensation data includes:
the first to third compensation parameter data for each unit block, and the local compensation parameter range data for each unit block of the compensation parameter determined as the local compensation parameter; and
the compensation parameter range data for all unit blocks of the compensation parameters that are not determined as the local compensation parameter, and
wherein the number of each of the first to third compensation parameter data, the local compensation parameter data, and the local compensation parameter range data included in the mura compensation data is substantially equal to the total number of unit blocks in each of the first to third captured image data.

4. The mura compensation apparatus according to claim 1, wherein a local compensation parameter determination part included in the mura compensation apparatus is configured to generate local data, which is data for the compensation parameter determined as the local compensation parameter among the first to third compensation parameters,
a mura compensation data output part included in the mura compensation apparatus is configured to output the mura compensation data by using the local data, and
wherein the mura compensation data includes:
the first to third compensation parameters for each unit block and the local compensation parameter range data for each unit block of the compensation parameter determined as the local compensation parameter;
the compensation parameter range data for all unit blocks of the compensation parameters that are not determined as the local compensation parameter; and
the local data.

5. The mura compensation apparatus according to claim 1, wherein a compensation parameter range calculation part included in the mura compensation apparatus is configured to calculate the range of each of the first to third compensation parameters for all unit blocks by using the first to third compensation parameters, to classify the range of each of the first to third compensation parameters according to a predetermined range reference, and to generate first to third compensation parameter range data for all unit blocks, and
a local compensation parameter determination part included in the mura compensation apparatus is configured to determine, among the first to third compensation parameters, a compensation parameter exhibiting the greatest variation in values for each unit block across all unit blocks as the local compensation parameter by using at least one of the range of each of the first to third compensation parameters and the first to third compensation parameter range data.

6. The mura compensation apparatus according to claim 1, wherein a compensation parameter range calculation part included in the mura compensation apparatus is configured to generate compensation parameter range data for all unit blocks according to a predetermined reference range, and
a mura compensation data output part included in the mura compensation apparatus is configured to:
for the compensation parameters that are not determined as the local compensation parameter,
divide the parameter range corresponding to the compensation parameter range data calculated for all unit blocks into a predetermined plurality of steps, and determines the step corresponding to each unit block's compensation parameter among the plurality of steps as the compensation parameter data for each unit block, and
for the compensation parameter determined as the local compensation parameter,
divide the parameter range corresponding to the compensation parameter range data calculated for each unit block into the predetermined plurality of steps, and determines the step corresponding to each unit block's compensation parameter among the plurality of steps as the compensation parameter data for each unit block.

7. A display driving apparatus comprising:
a register configured to store mura compensation data, the mura compensation data including first to third compensation parameter data for each unit block, local compensation parameter range data for each unit block of the compensation parameter determined as the local compensation parameter, and compensation parameter range data for all unit blocks of the compensation parameters that are not determined as the local compensation parameter; and
a display driver configured to restore the first to third compensation parameters for each unit block by using the mura compensation data and to calculate a mura compensation value.

8. The display driving apparatus according to claim 7, wherein the number of each of the first to third compensation parameters and the local compensation parameter range data for each unit block of the compensation parameter determined as the local compensation parameter included in the mura compensation data is substantially equal to the total number of unit blocks in each of the first to third captured image data.

9. The display driving apparatus according to claim 7, wherein the mura compensation data further includes local data, which is data for the compensation parameter determined as the local compensation parameter among the first to third compensation parameters.

10. The display driving apparatus according to claim 9, wherein the display driver is configured to:
set the local compensation parameter among the first to third compensation parameters by using the local data,
for the compensation parameter set as the local compensation parameter, to restore the compensation parameter by using the compensation parameter data of the compensation parameter for each unit block of the corresponding compensation parameter and the compensation parameter range data for each unit block of the corresponding compensation parameter, and
for the compensation parameters that are not determined as the local compensation parameter, to restore the compensation parameter by using the compensation parameter data of the compensation parameter for each unit block of the corresponding compensation parameter and the compensation parameter range data for all unit blocks of the corresponding compensation parameter.
